(19) United States
(12) Patent Application Publication
(10) Pub. No.: US 2010/0304233 A1
(43) Pub. Date: Dec. 2, 2010

(54) FUEL CELL ASSEMBLY

(75) Inventors: Mohinder S. Bhatti, Williamsville, NY (US); John F. O'Brien, Lockport, NY (US); Ilya Reyzin, Williamsville, NY (US)

Correspondence Address: DELPHI TECHNOLOGIES, INC, M/C 480-410-202, PO BOX 5052, TROY, MI, 48007, US

(73) Assignee: DELPHI TECHNOLOGIES, INC., Troy, MI (US)

(21) Appl. No.: 12/473,561

(22) Filed: May 28, 2009

(51) Int. Cl. H01M 8/04

(52) U.S. Cl. 429/413

(57) ABSTRACT

A fuel cell assembly for using hydrogen gas and oxygen to produce electrical energy. The cathode of the fuel cell produces water vapor to define a flow of moist air including water vapor. A dehumidifier receives the flow of moist air including water vapor to produce purified liquid water and a flow of dehumidified air. The dehumidifier has an air inlet having a first cross-sectional area and an air outlet having a larger second cross-sectional area. The diffuser cavity of the dehumidifier progressively increases in size from the air inlet to the air outlet for depressurizing and cooling the flow of moist air including water vapor below the dew point of the moist air including water vapor to condense the water vapor on the housing of the dehumidifier.

### BACKGROUND OF THE INVENTION

1. Field of the Invention

A fuel cell assembly for using hydrogen gas and oxygen to produce electrical power.

2. Description of the Prior Art

The present invention is directed at an air dehumidification device for a relatively low temperature proton exchange membrane (PEM) fuel cell, whose operating temperature ranges from 50-100° C. (122-212° F.). This type of fuel cell is especially suitable for motor vehicles and other mobile applications. By contrast, the high temperature solid oxide fuel cell (SOFC) with operating temperature in the range 500-1000° C. (932-1832° F.) is suitable for all sizes of combined heating and power (CHP) generation systems ranging from 2 kW to multi MW capacity.

PEM fuel cells generally include a cathode and an anode in spaced relationship to one another, and a proton exchange membrane (PEM) sandwiched between the cathode and anode. An electrical circuit is spaced from the fuel cell and electrically interconnects the cathode and anode. The cathode of the fuel cell receives a flow of hydrogen molecules (H₂) and splits the hydrogen molecules into protons, or Hydrogen ions (H⁺), and electrons (e⁻). The protons (H⁺) diffuse through the PEM, and the electrons (e⁻) flow through the electrical circuit to provide electrical power.

The cathode of the fuel cell receives a flow of air including oxygen (O₂) and the protons (H⁺) from the PEM and the electrons (e⁻) from the electrical circuit to produce water (H₂O) vapor. Some of the water remains in the fuel cell to moisten the PEM and some of it flows out of the cathode with the air leaving the cathode. It is important to make sure that enough water is removed from the cathode for otherwise the cathode of the fuel cell will be starved of oxygen required for the electrical power generation. However, enough water must remain in the cathode to diffuse into the PEM to prevent the PEM from drying up. If the PEM dries up, the fuel cell can overheat and its efficiency is substantially reduced. Further, it is important to condition the air properly with a lower humidity before it enters the cathode of the fuel cell. Consequentially, water management is extremely important for PEM fuel cell assemblies.

U.S. Pat. No. 4,769,297, issued to Reiser et al. on Sep. 6, 1988 (hereinafter referred to as Reiser '297), discloses a fuel cell system including a fuel cell for receiving a plurality of hydrogen molecules and a flow of air including oxygen for producing electrical energy and a flow of moist air including water vapor. A dehumidifier (condenser) is in fluid communication with the fuel cell for receiving the flow of moist air including water vapor and for condensing the water vapor to produce a flow of purified liquid water and a flow of dehumidified air. The dehumidifier has a housing including an air inlet having a first cross-sectional area for receiving the flow of moist air including water from the fuel cell and an air outlet having a second cross-sectional area for dispensing the flow of dehumidified air. The housing also has an air channel for conveying the flow of air from the air inlet to the air outlet. The dehumidifier works by diffusing water vapor across a semi-permeable membrane (porous hydrophilic separator plate). However, such a dehumidifier requires that the temperature and pressure be higher on one side of the semi-permeable membrane than on the other. There is a continuing need to develop dehumidifiers for fuel cell assemblies that are cheaper to produce, easier to produce, easier to operate and occupy less space than the prior art dehumidifiers for fuel cell assemblies.

### SUMMARY OF THE INVENTION

The invention provides for such a PEM fuel cell assembly wherein the diffuser cavity of the housing progressively increases in size from the air inlet to the air outlet for depressurizing and cooling the flow of moist air including water vapor below the dew point of the moist air to condense the water vapor on the housing of the dehumidifier to produce a flow of purified liquid water and a flow of dehumidified air.

As explained above, it is important to condition the air properly with lower humidity before it enters the cathode of the fuel cell. The dehumidifier of the PEM fuel cell assembly of the present invention is substantially more robust and less fragile than the dehumidifiers of the prior art. The present invention occupies less space than the prior art dehumidifiers. The present invention requires less compressor power to condition the air than the prior art dehumidifiers for fuel cell assemblies because it utilizes the high pressure spent air leaving the fuel cell without decompressing it completely. Lastly, the dehumidifier of the present invention can be manufactured much cheaper than the dehumidifiers of the prior art because it can be injection molded out of a conductive plastic material.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective and exploded view of the dehumidifier;

FIG. 2 is a flow chart of the PEM fuel cell assembly of the present invention; and

FIG. 3 is a cross-sectional view of the dehumidifier of the present invention taken along line 3-3 of FIG. 1.

### DETAILED DESCRIPTION OF THE EXEMPLARY EMBODIMENT

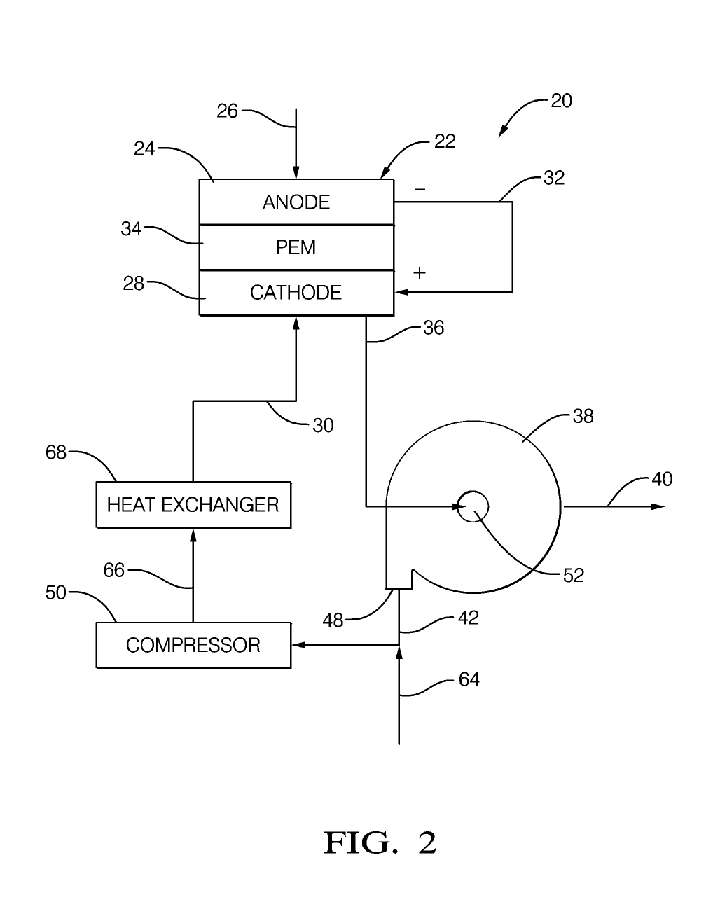

Referring to the Figures, wherein like numerals indicate corresponding parts throughout the several views, the invention is a fuel cell assembly 20, generally shown in FIG. 2, for using hydrogen gas and oxygen to produce electrical energy.

The assembly 20 includes a PEM fuel cell 22, generally indicated, including an anode 24 for receiving a plurality of hydrogen molecules 26 (H₂), which ionizes at the anode 24, releasing hydrogen ions, or protons (H⁺), and electrons (e⁻) in accordance with the following reaction:

2H₂→4H⁺+4e⁻ (1)

The fuel cell 22 further includes a cathode 28 spaced from the anode 24 for receiving the protons (H⁺) and electrons (e⁻) from the anode 24 of the fuel cell 22 and for receiving a flow of compressed and cooled air including oxygen 30 (O₂). The flow of compressed and cooled air including oxygen 30 must be properly conditioned with dry bulb temperature about 80° C. (176° F.), pressure ˜2 atmospheres and relative humidity ˜20%.

The electrons (e⁻) released by the anode 24 must reach the cathode 28 through an external electrical circuit 32 in order to produce electric power. In the presence of moisture, the protons (H⁺) are transported from anode 24 to cathode 28 through a proton exchange membrane (PEM) 34 sandwiched between the anode 24 and cathode 28 of the fuel cell 22. Transport of the protons (H⁺) across the PEM 34 occurs in the form of hydronium (H₃O⁺) ions. This transport of hydronium (H₃O⁺) ions is caused by an electro-osmotic process and is dependent upon the water content of the PEM membrane 34. The electro-osmotic drag is believed to transport one or two water molecules (H₂O) with each proton (H⁺). Thus, the PEM 34 continuously loses water in operation as the protons (H⁺) are transported from the anode 24 to the cathode 28 through the PEM 34 in the form of hydronium (H₃O⁺) ions by the electro-osmotic process. As the PEM 34 dries up, it progressively transports fewer and fewer hydronium (H₃O⁺) ions. If a PEM fuel cell 22 continues to be operated without adequate water content, the overly dry parts of the PEM 34 begin to generate added electrical resistance, which produces heat and accelerates the drying process. This leads to a significant reduction in the fuel cell 22 output, overheating and even destruction of the fuel cell 22. Therefore, it is clear that water management in the fuel cell assembly 20 is of paramount importance to ensure its smooth and continuous operation.

While there is a continuous loss of water vapor at the anode 24, there is a continuous generation of water vapor at the cathode 28. At the cathode 28 of the fuel cell 22, oxygen (O₂) reacts with electrons (e⁻) flowing from the electrical circuit 32 and protons (H⁺) diffusing across the PEM 34 to produce water vapor (H₂O) in accordance with the following reaction:

O₂+4e⁻+4H⁺−2H₂O (2)

In view of this chemical reaction, excess water (H₂O) is available on the cathode 28 side of the PEM 34 from both the chemical reaction and the electro-osmotic transport effects. There is some diffusion of excess water (H₂O) back from the cathode 28 to the anode 24, but this is insufficient to prevent excessive PEM 34 drying under high current operating conditions. The accumulated water vapor (H₂O) on the cathode 28 side of the fuel cell 22 must be removed promptly to maintain oxygen access to the reaction sites on the cathode 28 side of the PEM 34. This excess water vapor (H₂O) leaves the cathode 28 of the fuel cell 22 in a flow of moist air 36.

Clearly, for both the reactions of Equations (1) and (2) and to proceed continuously, electrons (e⁻) produced at the anode 24 must pass through an electrical circuit 32 to the cathode 28. Also, the protons (H⁺) produced at the anode 24 must pass through the PEM 34. A solid polymer possesses free hydrogen ions (H⁺) and as such effectively transfers the protons (H⁺) from the anode 24 to the cathode 28. It should be noted that the PEM 34 must only allow hydrogen ions (H⁺) to pass through it and not electrons (e⁻). Otherwise the electrons (e⁻) would go through the PEM 34 instead of going round the electrical circuit 32 and resulting in no electrical power production.

In order to maximize the effectiveness of the fuel cell 22, it is desirable to keep the PEM 34 moist. To supply the PEM 34 with moisture, a portion of the water vapor (H₂O) produced at the cathode 28 is distributed across the PEM 34.

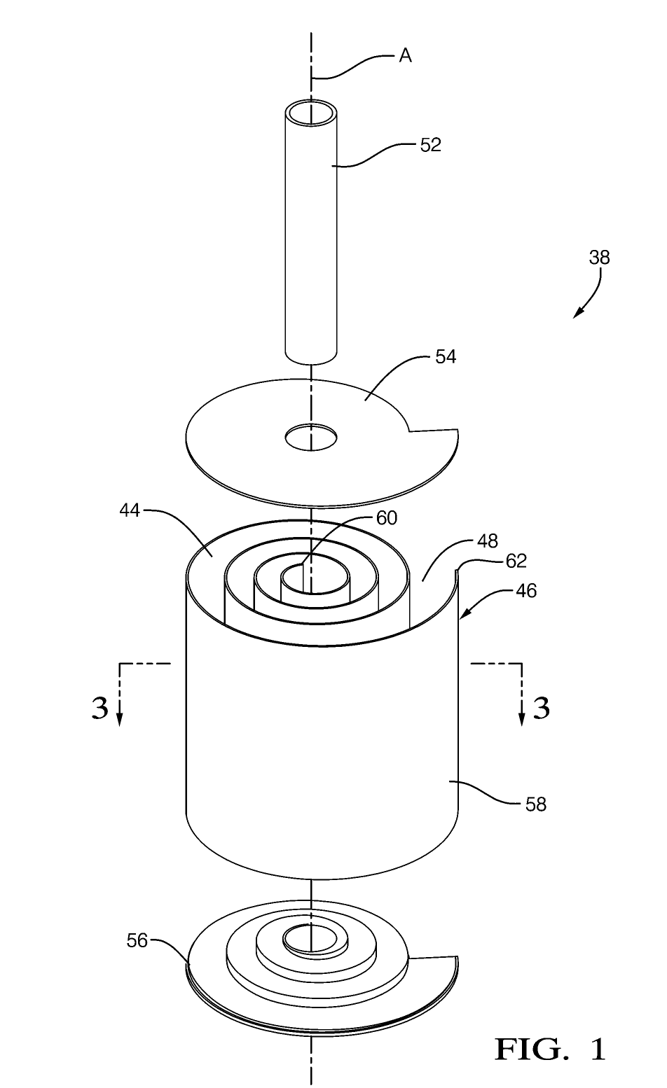

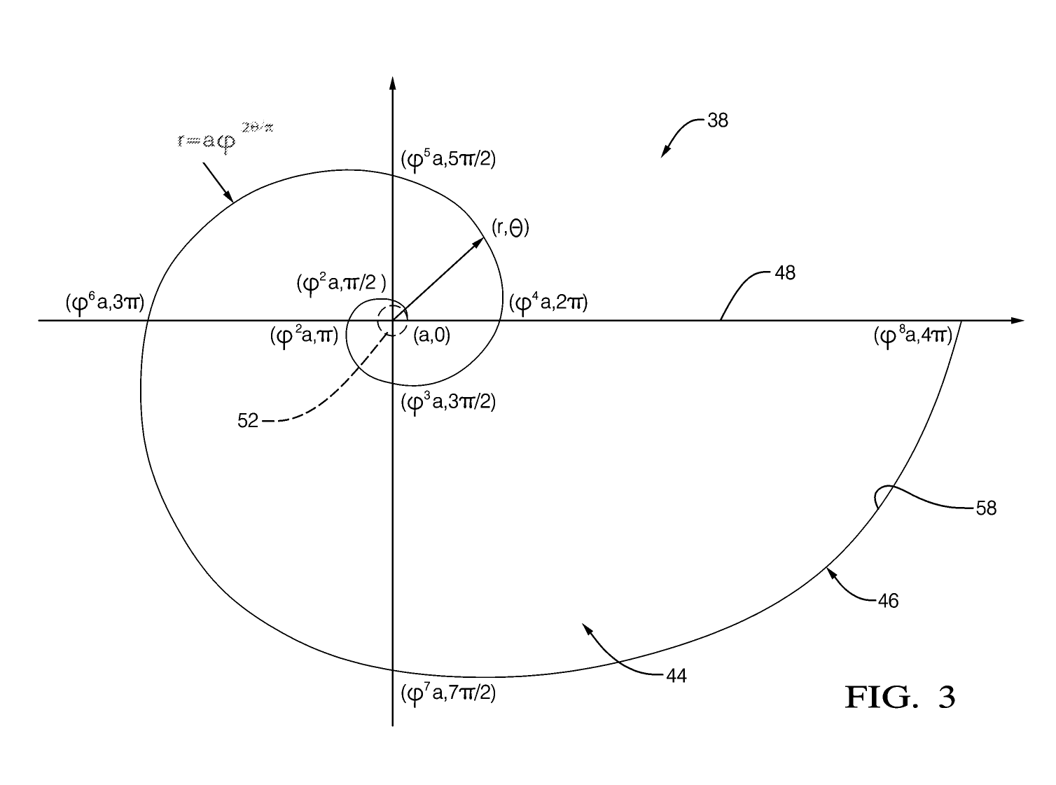

The assembly 20 further includes a dehumidifier 38, generally shown in FIGS. 1 and 3. The dehumidifier 38 is in fluid communication with the cathode 28 of the fuel cell 22 for receiving the flow of moist air 36 from the cathode 28 of the fuel cell 22. The dehumidifier 38 condenses the water vapor to produce a flow of purified liquid water 40 and a flow of dehumidified air 42. The flow of purified liquid water 40 can be used for any purpose, e.g. as drinking water. The dehumidifier 38 of the exemplary embodiment is external to the fuel cell 22, and as such is easy to maintain independent of the fuel cell 22.

The dehumidifier 38 performs two distinct functions—expansion of the incoming moisture-laden air with drop in dry bulb temperature and removal of the desired amount of water vapor from it. It comprises a spiral-shaped diffuser cavity 44 with a continuously increasing radial gap between the adjoining walls of the cavity. Such a cavity can be formed by erecting a housing 46 in the shape of a spiral as shown in FIGS. 1 and 3.

The housing 46 includes a first cross-sectional area disposed on an axis A for receiving the flow of moist air 36 from the cathode 28 of the fuel cell 22 and an air outlet 48 having a second cross-sectional area for dispensing the flow of dehumidified air 42 to a compressor 50 (explained in more detail below). The housing 46 of the dehumidifier 38 further defines the spiral-shaped diffuser cavity 44 for conveying the flow of air from the air inlet pipe 52 to the air outlet 48. An air inlet pipe 52 feeds moisture-laden air from the cathode 28 of the fuel cell 22 to the dehumidifier 38.

In the exemplary embodiment, the housing 46 of the dehumidifier 38 extends radially outwardly from the axis A and has a top plate 54 and a bottom plate 56 in spaced and parallel relationship with one another. A scroll 58 in the shape of a spiral is disposed in the housing 46 and extends axially between the top and bottom plates 54, 56. The scroll 58 has a first end 60 and a second end 62. The scroll 58 spirals radially outwardly to define at least one coil as viewed in cross-section from the first end 60 engaging the air inlet pipe 52 to the second end 62 defining the air outlet 48. The scroll 58 in the housing 46 defines the diffuser cavity 44 as extending from the air inlet pipe 52 on the axis A to the air outlet 48 adjacent the second end 62 of the spiral-shaped scroll 58.

In the exemplary embodiment, the spiral-shaped scroll 58 is further characterized by the following equation representing the cross-section of the scroll 58:

r=ac^{θ} (3)

where
θ is the polar angle measured in radians from the axis A corresponding to r=a as shown in FIG. 3,
r is the local radial distance of the diffuser cavity 44 measured from the axis A,
a is the inside radius of the inlet pipe measured from the axis A, and
c is a constant given by the relation

c=φ^{2/π} (4)

where

$$ϕ = ( \frac{1 + \sqrt{5}}{2} ) = 1.618034 \qquad ( 5 )$$

Introducing Equation (5) into Equation (4), we have c=1.358456. Equation (3) represents a spiral-shaped curve, which gets wider by a factors φ=1.618034, given in Equation (5) and called golden ratio, for every quarter turn it makes about the axis A. In other words, the diffuser cavity 44 represented by Equation (3) expands by a factor of φ for every π/2 increase in the polar angle θ.

Combining Equations (3)-(5), the equation of the cross-section of the scroll 58 can be expressed as:

r=aφ^{2θ/π}=1.618034^{2θ/π}a (6)

The incoming air flow through air inlet pipe 52 with inside radius a impinges on the bottom plate 56 and flows tangentially into the expanding diffuser cavity 44. According to Equation (6), r/a=1 for θ=0. Furthermore, according to Equation (6), as the flow expands by quarter turn to θ=π/2, the diffuser cavity 44 radius r becomes r=φa. When the flow expands by another quarter turn to θ=π, the diffuser cavity 44 radius r becomes r=φ²a. When the flow expands by another quarter turn to θ=3π/2, the diffuser cavity 44 radius r becomes r=φ³a. When the flow expands to θ=2π, the diffuser cavity 44 radius r becomes r=φ⁴a. When the flow expands to θ>2π the diffuser cavity 44 housing 46 begins to wrap around itself continuing to expand ad infinitum by a factor of φ=1.618034 for every quarter turn. Thus, for example, when the flow expands to θ=5π/4, the diffuser cavity 44 radius r becomes r=φ⁵a.

The foregoing numerical values show that the diffuser cavity 44 can be designed to expand ad infinitum to achieve any desired area of the air outlet 48. Such an expanding diffuser cavity 44 is essential to promote condensation of water vapor from the flow of moist air 36 in the diffuser cavity 44 and flowing from the air inlet pipe 52 to the air outlet 48. As the air expands, its dry bulb temperature drops with concomitant drop in its pressure. Once the temperature drops below the dew point temperature corresponding to the inlet pressure and inlet absolute humidity, the water vapor in the air begins to condense, first as mist, and then, as the temperature continues to drop below the dew point temperature, the mist coalesces into liquid droplets, which collect on the spiral-shaped scroll 58 as well as on the top plate 54 and the bottom plate 56. Eventually condensed liquid droplets gravitate to the bottom plate 56 whence they can be removed from the dehumidifier 38. As stated above, the liquid water that is condensed by the dehumidifier 38 is purified and can be used for any purpose, e.g. as drinking water. A flow of dehumidified air 42 exits the dehumidifier 38 through the air outlet 48.

Each of the components of the dehumidifier 38, i.e. the top and bottom plates 54, 56, the air inlet pipe 52, and the scroll 58, is preferably made of an injection molded conductive plastic, but may be made of any material and according to any manufacturing process.

The inlet and outlet temperatures and pressures in the dehumidifier 38 are governed by the following equation:

$$\frac{{T}_{2}}{{T}_{1}} = \{ 1 + {η}_{e} [ {( \frac{{P}_{2}}{{P}_{1}} )}^{( γ - 1 ) / γ} - 1 ] \} \qquad ( 7 )$$

where

T₁ is the temperature of the moist air 36 entering the dehumidifier 38,

T₂ is the temperature of the flow of dehumidified air 42 exiting the dehumidifier 38,

P₁ is the pressure of the moist air 36 entering the dehumidifier 38,

P₂ is the pressure of the flow of dehumidified air 42 exiting the dehumidifier 38,

ηₑ is the efficiency of the diffuser cavity 44 which has a value in the range 0.8-0.9,

γ=cₚ/cᵥ=1.4 is the specific heat ratio of moist air,

cₚ is the heat capacity of the flow of air at a constant pressure and

cᵥ is the heat capacity of the flow of air at a constant volume.

From the operation of the fuel cell 22, the air temperature T₁ and the pressure P₁ at the air inlet 52 are known. Also from the design of the spiral-shaped scroll 58, the air pressure P₂ at the air outlet 48 is known. Thus knowing T₁, P₁ and P₂, the air temperature T₂ at the air outlet 48 can be calculated using Equation (7) with γ=1.4 and ηₑ=0.85.

The Table below shows an example of the various properties of the flow of air through the dehumidifier 38. As can be seen, the air cools and loses pressure as it expands through the diffuser cavity 44 of the dehumidifier 38. As the air depressurizes and cools, its relative humidity increases to 1, upon reaching the dew point. As the air continues to expand and cool below the dew point, the relative humidity remains fixed at 1, but the absolute humidity drops, resulting in the air shedding the water vapor in the form of condensation on the housing 46 of the dehumidifier 38. The housing 46 of the dehumidifier 38 then collects the condensation as explained above.

| | Air Inlet Pipe | At Dew Point | Air Outlet |
|---|---|---|---|
| Air Temperature (° F.) | 176 | 154 | 110 |
| Air Pressure (psia) | 26.1 | 22.7 | 16.5 |
| Mass Flow Rate of Air | 14.55 | 14.55 | 14.55 |
| (lbₘ/min) | | | |
| Absolute Humidity of Air | 0.1664 | 0.1664 | 0.0525 |
| (lbₘH₂O/lbₘair) | | | |
| Relative Humidity of Air | 0.5 | 1 | 1 |
| Mass Flow Rate of Water | 2.42 | 2.42 | 0.76 |
| Vapor (lbₘ/min) | | | |

The fuel cell assembly 20 further includes a compressor 50 in fluid communication with the dehumidifier 38 for receiving the flow of dehumidified air 42 from the dehumidifier 38 and a flow of ambient air including oxygen 64. In operation, the compressor 50 compresses the mixture of the dehumidified air 42 and ambient air 64 to a prescribed pressure P₄ to define a flow of compressed air including oxygen 66 for the proper operation of the fuel cell 22.

The inlet and outlet temperatures and pressures in the compressor 50 are governed by the following equation:

$$\frac{{T}_{4}}{{T}_{3}} = \{ 1 + \frac{1}{{η}_{c}} [ {( \frac{{P}_{4}}{{P}_{3}} )}^{( γ - 1 ) / γ} - 1 ] \} \qquad ( 8 )$$

where

T₃ is the temperature of the mixture of the flow of dehumidified air 42 and the flow of ambient air including oxygen 64 entering the compressor 50,

T₄ is the temperature of the flow of compressed air including oxygen 66 exiting the compressor 50,

P₃ is the pressure of the mixture of the flow of dehumidified air 42 and the flow of ambient air including oxygen 64 entering the compressor 50,

P₄ is the pressure of the flow of compressed air including oxygen 66 exiting the compressor 50,

η_{c} is the efficiency of the compressor 50, which has a value in the range 0.75-0.85, and

γ=cₚ/cᵥ=1.4 is the specific heat ratio of the moist air,

cₚ is the heat capacity of the flow of air at a constant pressure and

cᵥ is the heat capacity of the flow of air at a constant volume

The temperature T₃ and the pressure P₃ can be determined knowing the ambient air temperature and pressure together with the known temperature T₂ and pressure P₂ at the dehumidifier 38 outlet as described. Thus knowing T₃ and P₃ together with the prescribed value of P₄ for the proper operation of the fuel cell 22, the air temperature T₄ at the compressor 50 outlet can be calculated using Equation (8) with γ=1.4 and η_{c}=0.8.

In the exemplary embodiment, the fuel cell assembly 20 further includes a heat exchanger 68 in fluid communication with the compressor 50 for receiving the flow of compressed air including oxygen 66. The heat exchanger 68 cools the flow of compressed air including oxygen 66 to a predetermined temperature to define a flow of compressed and cooled air including oxygen 30. The flow of compressed and cooled air including oxygen 30 is then fed back to the cathode 28 of the fuel cell 22.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A fuel cell assembly for using hydrogen gas and oxygen to produce electrical energy comprising:
a fuel cell for receiving a plurality of hydrogen molecules and a flow of air including oxygen and for producing electrical energy and a flow of moist air including water vapor;
a dehumidifier in fluid communication with said fuel cell for receiving said flow of moist air including water vapor and for condensing said water vapor to produce a flow of purified liquid water and a flow of dehumidified air;
said dehumidifier including a housing defining an air inlet for receiving said flow of moist air including water vapor from said fuel cell and defining an air outlet spaced from said air inlet for dispensing said flow of dehumidified air;
said housing defining a diffuser cavity for conveying said flow of moist air from said air inlet to said air outlet;
said air inlet having a first cross-sectional area and said air outlet having a second cross-sectional area; and
said diffuser cavity of said housing of said dehumidifier progressively increasing in size from said first cross-sectional area of said air inlet to said second cross-sectional area of said air outlet for depressurizing and cooling said flow of moist air including water vapor being conveyed through said diffuser cavity below the dew point of said moist air to condense said water vapor on said housing of said dehumidifier to produce said flow of purified liquid water and said flow of dehumidified air.

2. The assembly as set forth in claim 1 including a scroll spiraling outwardly to define said diffuser cavity.

3. The assembly as set forth in claim 2 wherein said scroll defines a spiral as viewed in cross-section.

4. The assembly as set forth in claim 3 wherein the cross-section of said spiral-shaped scroll is defined by the equation:
r=1.618034^{2θ/π}a
where r is the local radial distance of the diffuser cavity measured from the axis;
θ is the polar angle measured in radians from the axis corresponding to r=a; and
a is the inside radius of the inlet pipe measured from the axis.

5. The assembly as set forth in claim 1 wherein said air inlet is further defined as an air inlet pipe extending along an axis.

6. The assembly as set forth in claim 1 wherein said air inlet is disposed on an axis and said housing of said dehumidifier extends radially outwardly from said axis.

7. The assembly as set forth in claim 6 wherein said housing of said dehumidifier includes a top plate and a bottom plate in spaced and parallel relationship with one another.

8. The assembly as set forth in claim 7 further including a scroll disposed in said housing of said dehumidifier and extending axially between said top and bottom plates.

9. The assembly as set forth in claim 8 wherein said scroll spirals radially outwardly to define at least one coil as viewed in cross-section.

10. The assembly as set forth in claim 9 wherein said scroll spirals radially outwardly from a first end disposed adjacent said air inlet to a second end defining said air outlet for defining said diffuser cavity as extending from said air inlet on said axis to said air outlet adjacent said second end of said spiral-shaped scroll.

11. The assembly as set forth in claim 10 wherein the cross-section of the said spiral-shaped scroll is defined by the equation:
r=1.618034^{2θ/π}a
where
r is the local radial distance of the diffuser cavity measured from the axis;
θ is the polar angle measured in radians from the axis corresponding to r=a; and
a is the inside radius of the inlet pipe measured from the axis.

12. The assembly as set forth in claim 11 wherein said spiral of said scroll has an exponentially increasing radius from said first end adjacent said air inlet to said second end radially spaced from said axis to further define said diffuser cavity as having a progressively increasing cross-sectional area from said air inlet on said axis to said air outlet for decreasing the pressure of the flow of moist air including water vapor being conveyed through said diffuser cavity to depressurize and cool the flow of moist air below the dew point of the moist air to condense the water vapor on said scroll and said top plate and said bottom plate of said housing of said dehumidifier.

13. The assembly as set forth in claim 1 wherein said fuel cell includes an anode for splitting the hydrogen molecules into protons and electrons.

14. The assembly as set forth in claim 13 wherein said fuel cell includes a cathode spaced from said anode for receiving the protons and the electrons from said anode of said fuel cell and for receiving the flow of air including oxygen to combine the protons and electrons and oxygen to produce liquid water and the flow of moist air including water vapor.

15. The assembly as set forth in claim 14 wherein said fuel cell includes a proton exchange membrane (PEM) sandwiched between said anode and said cathode for conveying the protons from said anode to said cathode and for receiving the liquid water from said cathode to moisten said PEM.

16. The assembly as set forth in claim 15 wherein said PEM is of a material pervious to water and pervious to protons and resistive to electrons.

17. The assembly as set forth in claim 16 including an electrical circuit spaced from said PEM and electrically interconnecting said anode and said cathode for conveying the electrons from said anode to said cathode.

18. The assembly as set forth in claim 1 further including a compressor in fluid communication with said dehumidifier for receiving the flow of dehumidified air from said dehumidifier and for receiving a flow of ambient air including oxygen and for compressing the dehumidified and ambient air to a prescribed pressure to define a flow of compressed air including oxygen.

19. The assembly as set forth in claim 18 further including a heat exchanger in fluid communication with said compressor for receiving the flow of compressed air including oxygen and for cooling the compressed air to a predetermined temperature to define a flow of compressed and cooled air including oxygen.

20. A fuel cell assembly for using hydrogen gas and oxygen to produce electrical energy comprising:
a fuel cell including an anode for receiving a plurality of hydrogen molecules and for splitting the hydrogen molecules into protons and electrons;
said fuel cell including a cathode spaced from said anode for receiving the protons and electrons from said anode of said fuel cell and for receiving a flow of compressed and cooled air including oxygen and to combine the protons and electrons and oxygen molecules to produce liquid water and a flow of moist air including water vapor;
said fuel cell including a proton exchange membrane (PEM) sandwiched between said anode and said cathode for conveying the protons from said anode to said cathode and for receiving the liquid water from said cathode to moisten said PEM;
said PEM being of a material pervious to water and pervious to protons and resistive to electrons;
an electrical circuit spaced from said PEM and electrically interconnecting said anode and said cathode for conveying the electrons from said anode to said cathode;
a dehumidifier in fluid communication with said cathode of said fuel cell for receiving the flow of moist air including water vapor and for condensing the water vapor to produce a flow of purified liquid water and a flow of dehumidified air;
a compressor in fluid communication with said dehumidifier for receiving the flow of dehumidified air from said dehumidifier and for receiving a flow of ambient air and for compressing the dehumidified and ambient air to a prescribed pressure to define a flow of compressed air including oxygen;
a heat exchanger in fluid communication with said compressor for receiving the flow of compressed air and for cooling the compressed air to a predetermined temperature to define a flow of compressed and cooled air including oxygen;
said dehumidifier including a housing including an air inlet pipe disposed on an axis for receiving the flow of moist air from said cathode of said fuel cell and an air outlet for dispensing the flow of dehumidified air to said compressor;
said housing of said dehumidifier defining a diffuser cavity for conveying the flow of air from said air inlet to said air outlet;
said housing of said dehumidifier extending radially outwardly from said axis and having a top plate and a bottom plate in spaced and parallel relationship with one another;
a scroll disposed in said housing and having a wall extending axially between said top and bottom plates and spiraling radially outwardly to define at least one coil as viewed in cross-section from a first end engaging said air inlet pipe to a second end defining said air outlet for defining said diffuser cavity as extending from said air inlet pipe on said axis to said air outlet adjacent said second end of said spiral-shaped scroll; and
said spiral-shaped scroll being further defined as having a spiral as viewed in cross-section and an exponentially increasing radius from said first end engaging said air inlet pipe to said second end radially spaced from said axis to further define said diffuser cavity as having a progressively increasing cross-sectional area from said air inlet pipe on said axis to said air outlet for depressurizing and cooling the flow of moist air including water vapor below the dew point of the moist air including water vapor to condense the water vapor on said scroll and said top plate and said bottom plate of said housing of said dehumidifier.
